(19) United States
(12) Patent Application Publication
(10) Pub. No.: US 2025/0035236 A1
(43) Pub. Date: Jan. 30, 2025

(54) CONDUIT CLIP

(71) Applicant: The Gillette Company LLC, Boston, MA (US)

(72) Inventors: Mark Knight Robinson, Frensham (GB); Charlotte Hampton, Reading (GB); Charlotte McMain, Boston, MA (US); Sana Pirmohamed, Reading (GB)

(21) Appl. No.: 18/359,105

(22) Filed: Jul. 26, 2023

(51) Int. Cl. F16L 3/137; F16L 3/08; F16L 3/13; F16L 3/223

(52) U.S. Cl. CPC F16L 3/137; F16L 3/085; F16L 3/13; F16L 3/223

(57) ABSTRACT

A conduit clip with a top surface defining a first partially enclosed ring extending from a front face to a rear face. A bottom surface defines a second partially enclosed ring extending from the front face to the rear face of the body. A first side face defines a first slot configured to receive a first flexible fastener. The first slot extends from the bottom surface to the top surface. A second side face defines a second slot configured to receive the first flexible fastener. The second slot extends from the bottom surface to the top surface.

### FIELD

The present disclosure relates generally to a conduit clip for attaching various types of conduits to a support structure.

### BACKGROUND

A cable harness mount, also known as a conduit clip, is designed to attach conduits, for example, pipes, sheaths, cables, wires and bundles thereof, to a support structure, such as an arm or frame on a portion of assembly equipment. The conduits generally transmit electrical power, electrical or optical signals, fluids or air to various pieces of equipment. The conduit(s) may be bound together by one or more straps, sleeves, zip ties or the like. Cable harnesses are commonly used in all types of assembly equipment, aircraft, automobiles and other vehicles and machinery. Such conduits are typically flexible and must be confined to follow a designated path between various attachment locations. Accordingly, they are typically attached to a substructure for retention purposes. For example, a cable harness for a piece of assembly equipment may need to be clipped around a support arm or portion of a frame without risk of damage from hot and/or moving components. The mounting of the conduit to a support structure restricts movement of the conduit, thus minimizing adverse effects of vibrations, abrasions and prevents the conduit from become pinched or trapped by moving parts.

For larger and more complicated machines or equipment, numerous cable harness mounts are required to attach many different types and sizes of conduits. It may also be necessary to change the direction of the path of the conduit. Accordingly, there is a need to mount a cable harness to a support structure along part or all of its length in a simple and time efficient manner. There is also a need to retain the conduit to a support structure that moves at high speed without becoming dislodged. Furthermore, there is a need to be able to remove the cable harness from the support structure to provide regular equipment or machine maintenance.

The discussion of shortcomings and needs existing in the field prior to the present disclosure is in no way an admission that such shortcomings and needs were recognized by those skilled in the art prior to the present disclosure.

### SUMMARY

In one aspect, the invention features, in general, a conduit clip with a top surface defining a first partially enclosed ring extending from a front face to a rear face. A bottom surface defines a second partially enclosed ring extending from the front face to the rear face of the body. A first side face defines a first slot configured to receive a first flexible fastener. The first slot extends from the bottom surface to the top surface. A second side face defines a second slot configured to receive the first flexible fastener. The second slot extends from the bottom surface to the top surface.

In another aspect, the invention features, in general, a conduit clip with a top surface defining a pair of partially enclosed rings extending from a front face to a rear face. A bottom surface defines a lower partially enclosed ring extending from the front face to the rear face of the body. A first side face defines a first slot configured to receive a first flexible fastener. The first slot extending from the bottom surface to the top surface. A second side face defines a second slot configured to receive the first flexible fastener, the second slot extending from the bottom surface to the top surface.

In another aspect, the invention features, in general, a method of securing conduit by providing a conduit clip. One or more sections of conduit are secured within a first partially enclosed ring defined by a top surface of the of the conduit clip. A portion of a tooling arm having a circular cross section is engaged against a bottom surface of the conduit clip. A flexible fastener is inserted through an opening of the conduit clip and around a portion of the tooling arm. The flexible fastener is secured around a portion of the tooling arm.

These and other features, aspects, and advantages of various embodiments will become better understood with reference to the following description, figures, and claims.

### BRIEF DESCRIPTION OF THE DRAWINGS

Many aspects of this disclosure can be better understood with reference to the following figures.

FIG. 1 is a partial perspective view of a portion of automation equipment.

FIG. 2A is a front perspective view of a conduit clip.

FIG. 2B is a rear perspective view of the conduit clip of FIG. 2A.

FIG. 2C is bottom perspective view of the conduit clip of FIG. 2A.

FIG. 3A is a front perspective view of another possible embodiment of a conduit clip.

FIG. 3B is a rear perspective view of the conduit clip of FIG. 3A.

FIG. 4 is a front perspective view of another possible embodiment of a conduit clip on a tooling arm.

FIG. 5 is a front perspective view of another possible embodiment of a conduit clip.

FIG. 6 is a perspective of the conduit clip of FIG. 5 secured to a conduit and a tooling arm.

FIG. 7 is a perspective of the conduit clip of FIG. 5 secured to a conduit and a tooling arm.

FIG. 8 is a perspective of the conduit clip of FIG. 5 secured to a conduit and a tooling arm.

It should be understood that the various embodiments are not limited to the examples illustrated in the figures.

### DETAILED DESCRIPTION

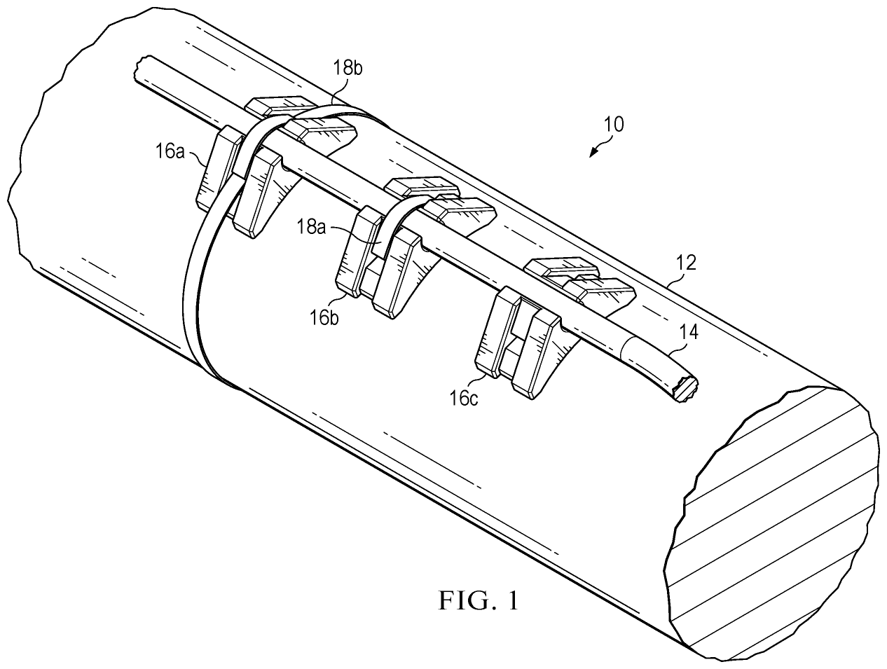

Referring to FIG. 1, a partial view of a portion of automation equipment 10 having tooling arm 12. The tooling arm 12 may be part of a robot or a frame of a piece of assembly equipment, which may be used for manufacturing. The tooling arm 12 may have one or more conduits 14 to carry electrical power, electrical or optical signals, fluids or air to various pieces of equipment. The conduit 14 may be attached to the tooling arm 12 utilizing one or more conduit clips 16a, 16b and 16c. Although three conduit clips 16a, 16b and 16c are shown, it is understood that more or less conduit clips 16a, 16b and 16c may be used depending on the size of the tooling arm 12 and/or the number of conduits 14 that are needed. One or more flexible fasteners (e.g., a first flexible fastener 18a and a second flexible fastener 18b) may be used to help secure the conduit 14 to the tooling arm 12 or to one of the conduit clips 16a, 16b and 16c. For example, the first flexible fastener 18a may wrap around at least a portion of both the conduit 14 and the conduit clip 16b to secure the conduit 14 to the conduit clip 16b. The second flexible fastener 18b may wrap around at least a portion of both the tooling arm 12 and the conduit clip 16a secure the conduit clip 16a to the tooling arm 12. Although FIG. 1 illustrates one of the flexible fasteners 18a on conduit clip 16b and only one of the flexible fasteners 18b on the conduit clip 16a, it is understood that a pair of the flexible fasteners 18a and 18b may be used on each of the conduit clips 16a, 16b and 16c to help secure the conduit 14 to the tooling arm 12 and to the respective conduit clips 16a. 16b and 16c. The flexible fasteners 18a and 18b may include straps and/or zip ties. In certain embodiments, an adhesive or other fastener may be used to secure the respective conduit clips 16a. 16b and 16c to the tooling arm 12.

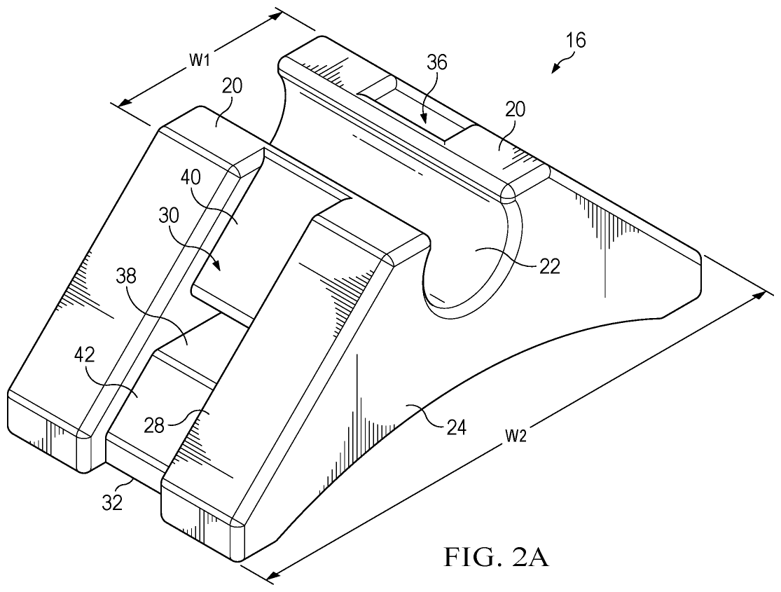

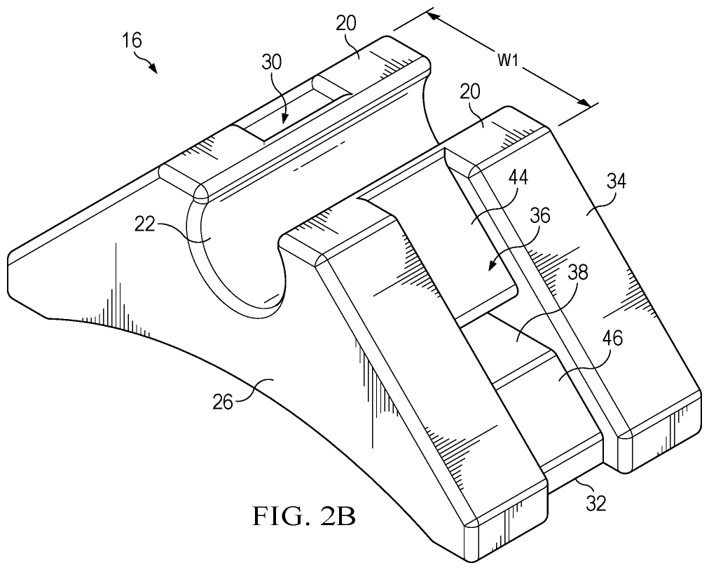

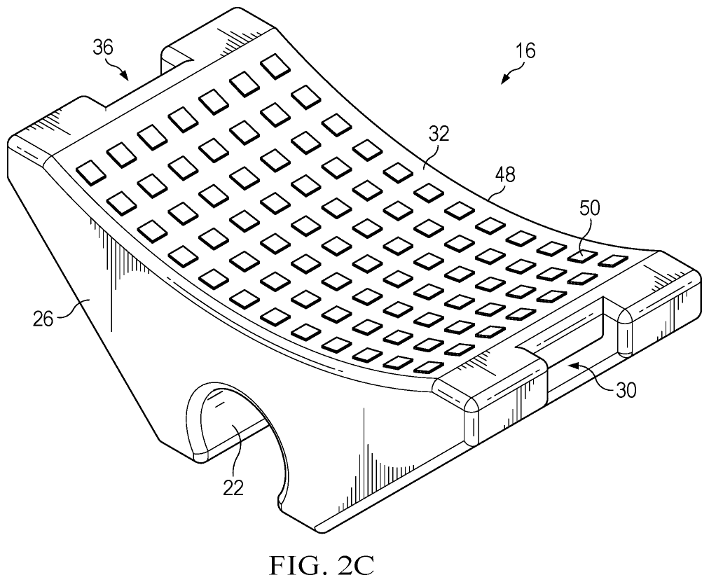

Referring to FIGS. 2A and 2B, a front perspective view and a rear perspective view of the conduit clip 16 is illustrated, respectively. The conduit clip 16 may have a top surface 20 defining a first partially enclosed ring 22 extending from a front face 24 to a rear face 26 of the conduit clip 16. The first partially enclosed ring 22 may be about 60% to about 80% and more preferably about 65% to about 70% enclosed to facilitate attaching and retaining the conduit 14 of FIG. 1. For example, the conduit 14 may be able to be easily pushed into partially enclosed ring 22, which holds the conduit 14 in place. The conduit clip 16 may have a first side face 28 connecting the front face 24 and the rear face 26. As shown in FIG. 2A, with additional reference to FIG. 2C, the first side face 28 may define a first slot 30 extending from a bottom surface 32 to the top surface 20 of the conduit clip 16. A second side face 34, opposite the first side face 28, may connect the front face 24 and the rear race 26. The top surface 20 may have a first width “W1” that extends from the first side face 28 to the second side face 34. Similarly, the bottom surface 32 may have a second width “W2” that extends from the first side face 28 to the second side face 34. The first side face 28 and the second side face 34 may taper towards each other, such that the first width “W1” is less than the second width “W2”, thus providing the conduit clip with a smaller profile.

As shown in FIG. 2B, with additional reference to FIG. 2C, the second side face 34 may define a second slot 36 extending from the bottom surface 32 to the top surface 20 of the conduit clip 16. The first slot 30 and the second slot 36 may be dimensioned to receive the first fastener 18a and the second fastener 18b (FIG. 1). The first side face 28 and the second side face 34 may define an opening 38 extending through the conduit clip 16 from the first side face 28 to the second side face 34. The opening 38 may be fully enclosed and dimensioned to receive the flexible fastener 18a, as shown in FIG. 1. The opening 38 may be positioned within the first slot 30 and the second slot 36. The first slot 30 may have an upper portion 40 and a lower portion 42. The upper portion 40 of the first slot 30 may be positioned between the opening 38 and the top surface 20. The lower portion 42 of the first slot 30 may be positioned between the opening 38 and the bottom surface 32. The second slot 36 may have an upper portion 44 and a lower portion 46. The upper portion 44 of the second slot 36 may be positioned between the opening 38 and the top surface 20. The lower portion 46 of the second slot 36 may be positioned between the opening 38 and the bottom surface 32. The first flexible fastener 18a (FIG. 1) may be positioned through the opening 38 and within the upper portions 40 and 44 of the first slot 30 and the second slot 36, respectively. The first flexible fastener 18a may be secured over the top surface 20 of the conduit clip 16 and the conduit 14 (FIG. 1). The second flexible fastener 18b (FIG. 1) may be positioned through the opening 38 and within the lower portions 42 and 46 of the first slot 30 and the second slot 36, respectively. The second flexible fastener 18b may be secured over the tooling arm 12 (FIG. 1) that is positioned against the bottom surface 32.

Referring to FIG. 2C, a bottom perspective view of the conduit clip 16 of FIG. 2A is illustrated. The bottom surface 32 of the conduit clip 16 may be curved to define a second partially enclosed ring 48 extending from the front face 24 to the rear face 26 (FIG. 2B). In certain embodiments, the bottom surface 32 may be textured to facilitate gripping the tooling arm 12 (FIG. 1). For example, the bottom surface 32 may include a plurality of gripping projections 50. In certain embodiments, the first partially enclosed ring 22 and the second partially enclosed ring 48 may extend in the same direction (e.g., parallel to each other). However, as will be explained in greater detail below, the direction of the first partially enclosed ring 22 and the second partially enclosed ring 48 may be altered to facilitate routing of the conduit 14 in various directions. A radius of the second partially enclosed ring 48 may be greater than a radius of the first partially enclosed ring. The second partially enclosed ring 48 may be less enclosed than the first partially enclosed ring 22 to provide a better mating surface to larger cylindrical surfaces of the tooling arm 12. For example, a diameter of the conduit 14 is typically much less than a diameter of the tooling arm 12 on the portion of automation equipment 10, as shown in FIG. 1.

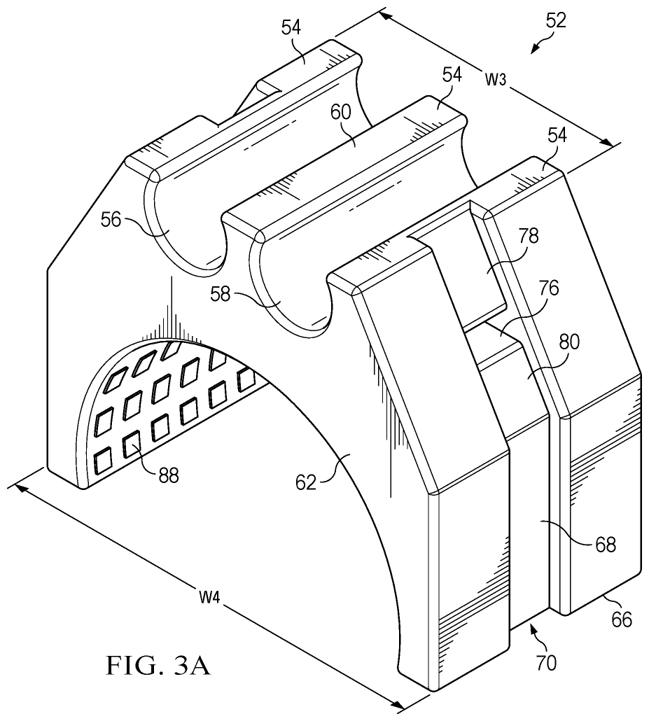

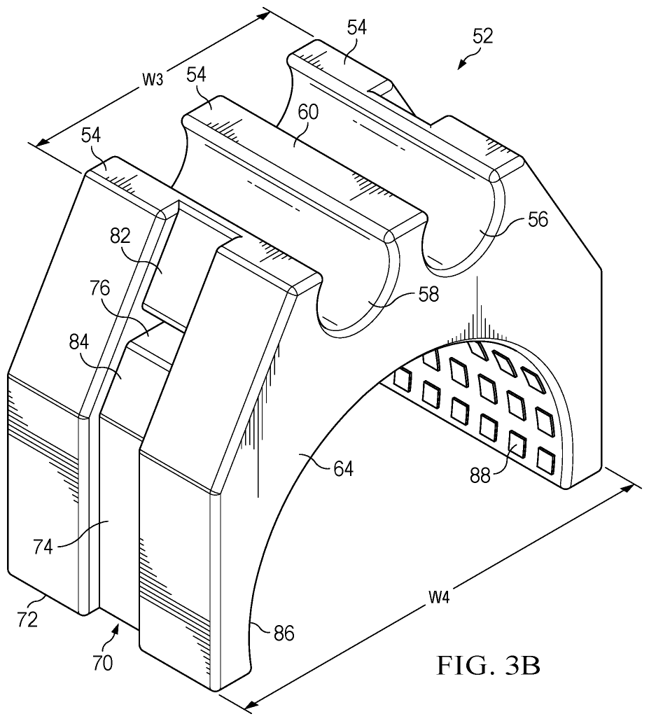

Referring to FIGS. 3A and 3B, a front perspective view and rear perspective view of another possible embodiment of a conduit clip 52 is illustrated, respectively. The conduit clip 52 may be similar to the conduit clip 16 of FIGS. 2A-2C. However, the conduit clip 52 may have a top surface 54 that defines a pair of partially enclosed rings 56 and 58 (e.g., first enclosed ring 56 and second enclosed ring 58). The pair of partially enclosed rings 56 and 58 may extend parallel to each other. The top surface 54 may include a middle portion 60 separating the pair of partially enclosed rings 56 and 58. The pair of partially enclosed rings 56 and 58 may extend from a front face 62 to a rear face 64 of the conduit clip 52. Each of the partially enclosed rings 56 and 58 may be dimensioned to receive and secure the conduit 14 (FIG. 1). Although the partially enclosed rings 56 and 58 are shown as having a similar size, it is understood that the size of the partially enclosed rings 56 and 58 may be different in order to receive different sized sections of conduit. For example, different sizes of the partially enclosed rings 56 and 58 may allow for different types and sizes of conduits to be secured with a single style conduit clip.

Each of the partially enclosed rings 56 and 58 may be about 60% to about 80% and more preferably about 65% to about 70% enclosed to facilitate retaining different sizes of conduit, such as the conduit 14 of FIG. 1. The conduit clip 52 may have a first side face 66 connecting the front face 62 and the rear face 64. As shown in FIG. 3A, the first side face 66 may define a first slot 68 extending from a bottom surface 70 to the top surface 54 of the conduit clip 52. A second side face 72, opposite the first side face 66, may connect the front face 62 and the rear race 64. As shown in FIG. 3B, the second side face 72 may define a second slot 74 extending from the bottom surface 70 to the top surface 54 of the conduit clip 52.

The top surface 54 may have a first width “W3” that extends from the first side face 66 to the second side face 72. Similarly, the bottom surface 70 may have a second width “W4” that extends from the first side face 66 and the second side face 72. The first side face 66 and the second side face 72 may taper towards each other, such that the first width “W3” is less than the second width “W4”, thus providing the conduit clip 52 with a smaller profile.

The first side face 66 and the second side face 72 may define an opening 76 extending through the conduit clip 52 from the first side face 66 to the second side face 72. The opening 76 may be positioned within the first slot 68 and the second slot 74. The opening 76 may be fully enclosed. The first slot 68 and the second slot 74 may be dimensioned to receive a flexible fastener, such as the first flexible fastener 18a and the second fastener 18b shown in FIG. 1.

The first slot 68 may have an upper portion 78 and a lower portion 80. The upper portion 78 of the first slot 68 may be positioned between the opening 76 and the top surface 54. The lower portion 80 of the first slot 68 may be positioned between the opening 76 and the bottom surface 70. The second slot 74 may have an upper portion 82 and a lower portion 84. The upper portion 82 of the second slot 74 may be positioned between the opening 76 and the top surface 54. The lower portion 84 of the second slot 74 may be positioned between the opening 76 and the bottom surface 70. The first flexible fastener 18a (e.g., FIG. 1) may be positioned through the opening 76 and within the upper portions 78 and 82 of the first slot 68 and the second slot 74, respectively. The first flexible fastener 18a may be secured over the top surface 54 (including middle portion 60) of the conduit clip 52 and the conduit 14 (e.g., FIG. 1). The second flexible fastener 18b (e.g., FIG. 1) may be positioned through the opening 76 and within the lower portions 80 and 84 of the first slot 68 and the second slot 74, respectively. The second flexible fastener 18b may be secured over the tooling arm 12 (e.g., FIG. 1). The bottom surface 70 may define a lower partially enclosed ring 86 that is configured to receive a portion of the tooling arm 12 (FIG. 1).

The lower partially enclosed ring 86 may extend from the front face 62 to the rear face 64. In certain embodiments, the bottom surface 70 may be textured to facilitate gripping the tooling arm 12 (FIG. 1). For example, the bottom surface 70 may include a plurality of gripping projections 88. In certain embodiments, the pair of partially enclosed rings 56 and 58 and the lower partially enclosed ring 86 may extend in the same direction (e.g., parallel to each other). However, it is understood, the direction of the lower partially enclosed ring 86 and the pair of partially enclosed rings 56 and 58 may be altered to facilitate routing of the conduit 14 in various directions. A radius of the lower partially enclosed ring 86 may be greater than a radius of the pair of partially enclosed rings 56 and 58. The lower partially enclosed ring 86 may be less enclosed than the pair of partially enclosed rings 56 and 58 to provide a better mating surface to larger cylindrical surfaces of the tooling arm 12. For example, a diameter of the conduit 14 is typically much less than a diameter of the tooling arm 12 on the portion of automation equipment 10, as shown in FIG. 1.

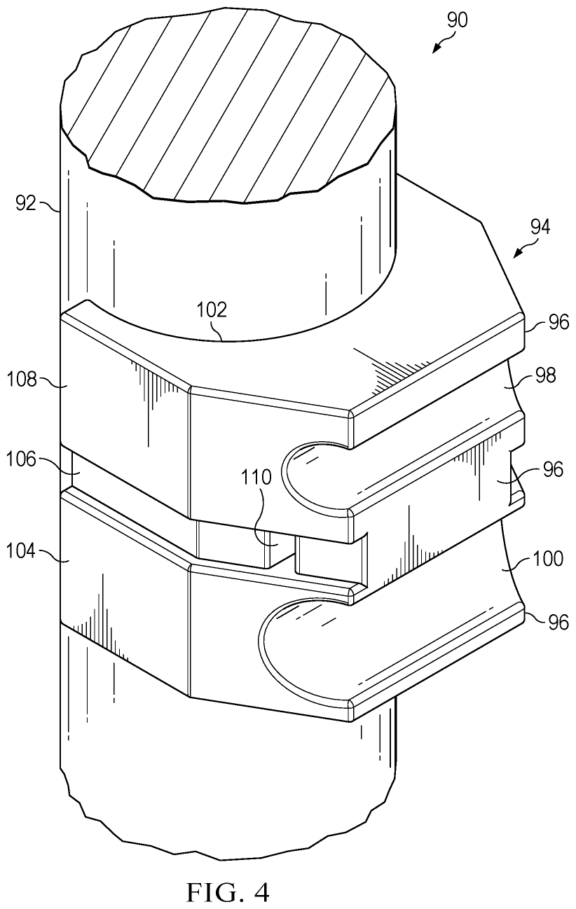

Referring to FIG. 4, a partial view of a portion of automation equipment 90 having tooling arm 92. The tooling arm 92 may be part of a robot or a frame of a piece of assembly equipment, which may be used for manufacturing. The tooling arm 92 may have one or more conduit clips 94, similar to the conduit clip 52 shown in FIG. 3. However, the conduit clip 94 may have a top surface 96 that defines one or more partially enclosed rings 98 and 100 (e.g., dimensioned to receive the conduit 14, shown in FIG. 1) that extend in a direction perpendicular to a direction of a lower partially enclosed ring 102 dimensioned to receive a portion of the tooling arm 92. Accordingly, the conduit 14, such as the conduit 14 shown in FIG. 1 may be directed in a direction that is not in line with the tooling arm 92 to which the conduit clip 94 is attached.

As shown in FIG. 4, a first side face 104 of the conduit clip 94 may define a first slot 106 extending from a bottom surface 108 to the top surface 96 of the conduit clip 94. The first side face 104 may define an opening 110 extending through the conduit clip 94. The opening 110 may be positioned within the first slot 106. The opening 110 may be fully enclosed and dimensioned to receive a flexible fastener, such as the flexible fasteners 18a and 18b of FIG. 1. The flexible fastener (not shown) may wrap around the bottom surface 108 of the conduit clip 94 and around the tooling arm 92, thus securing the conduit clip 94 to the tooling arm 92. FIG. 4 also illustrated that flexible fasteners may be optional to secure conduit within the partially enclosed rings 98 and 100. However, it is understood that flexible fasteners may be used for additional security, for example, if the tooling arm 92 moves such that conduit may become dislodged from the partially enclosed rings 98 and 100.

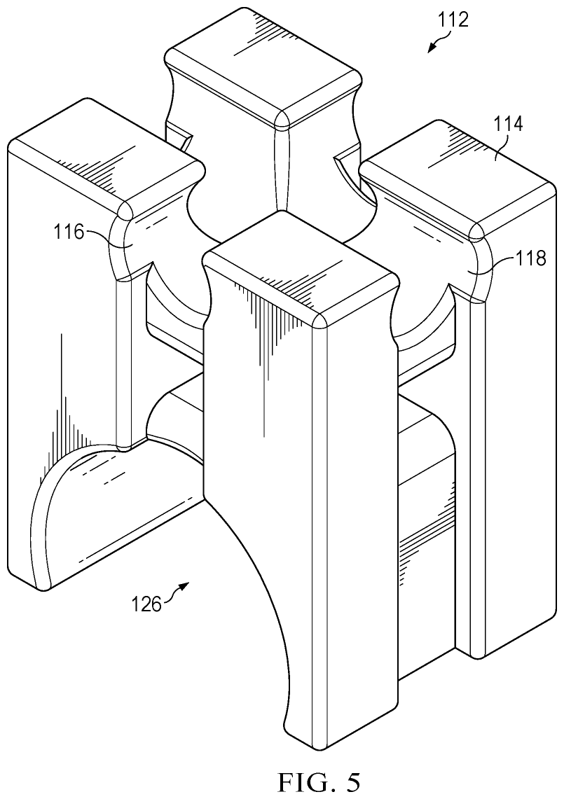

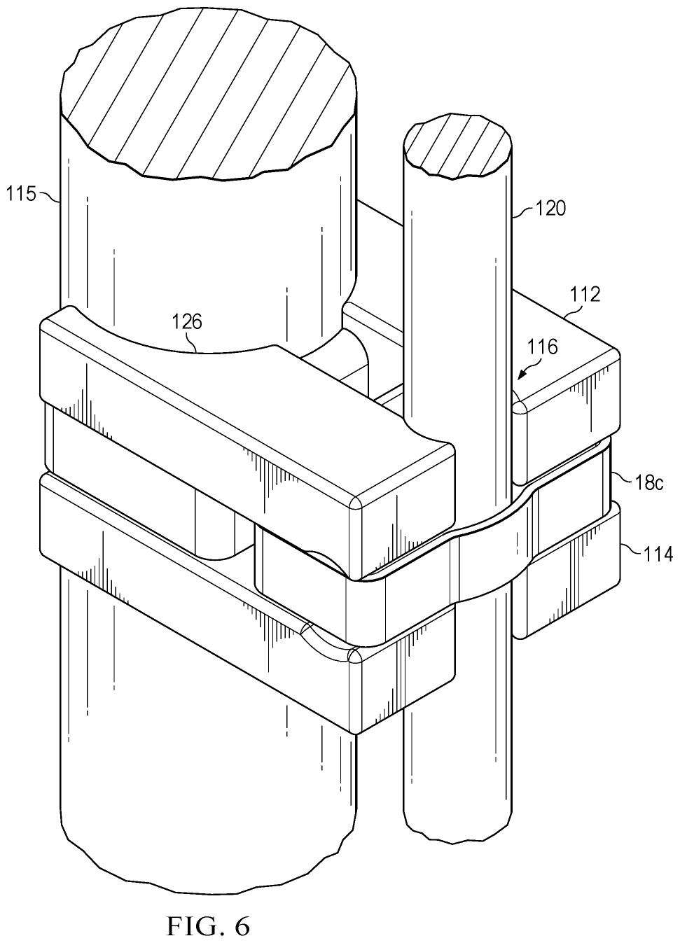

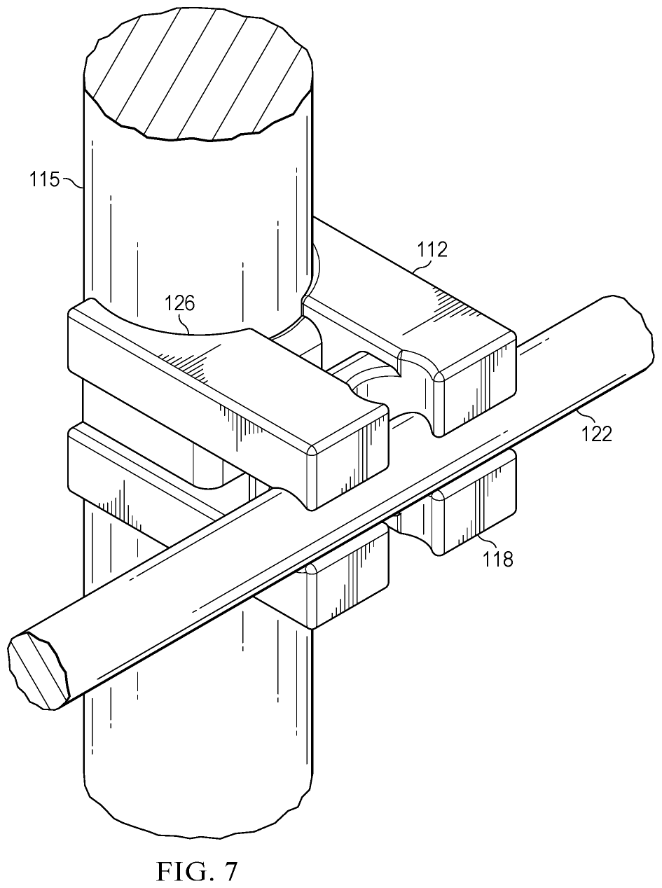

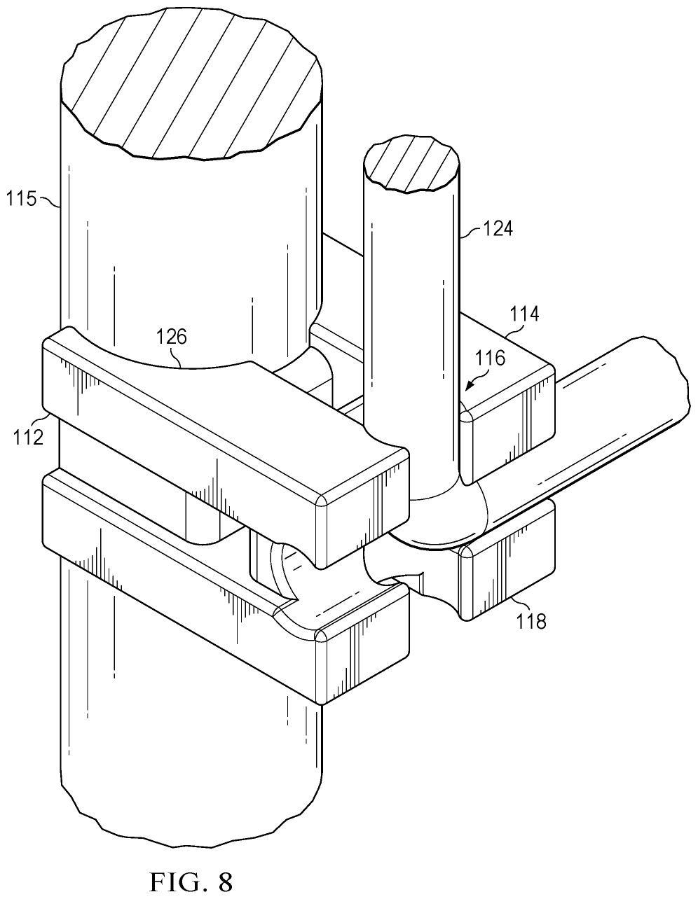

Referring to FIG. 5, a perspective view of a conduit clip 112 is illustrated, which may be used with a tooling arm 115 (FIGS. 6, 7 and 8). The conduit clip 112 may have a top surface 114 that defines a first partially enclosed ring 116 extending in a first direction and a second partially enclosed ring 118 extending in a second direction that is not parallel to the first direction. Although FIG. 5 illustrates the first partially enclosed ring 116 extending 90 degrees (perpendicular) to the enclosed ring 118, it is understood that other angles may be used. Accordingly, a conduit 120 may be positioned within the first partially enclosed ring 116, as shown in FIG. 6 or a conduit 122 may be positioned within the second partially enclosed ring 118, as shown in FIG. 7. In certain embodiments, a conduit 124 may be positioned within both the first partially enclosed ring 116 and the second partially enclosed ring 118, as shown in FIG. 8. Accordingly, the conduit clip 112 may be used to change the direction of the conduit 124.

The dimensions and values disclosed herein are not to be understood as being strictly limited to the exact numerical values recited. Furthermore, dimensions should not be held to an impossibly high standard of metaphysical identity that does not allow for discrepancies due to typical manufacturing tolerances. Therefore, the term “about” should be interpreted as being within typical manufacturing tolerances.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the invention. It is therefore intended to cover, in the appended claims, all such changes and modifications that are within the scope of this invention.

1. A conduit clip comprising:
a top surface defining a first partially enclosed ring extending from a front face to a rear face;
a bottom surface defining a second partially enclosed ring extending from the front face to the rear face of the body,
a first side face defining a first slot configured to receive a first flexible fastener, the first slot extending from the bottom surface to the top surface; and
a second side face defining a second slot configured to receive the first flexible fastener, the second slot extending from the bottom surface to the top surface.

2. The conduit clip of claim 1 wherein the first side face defines an opening extending to the second side face.

3. The conduit clip of claim 2 wherein the opening is positioned within the first slot and the second slot.

4. The conduit clip of claim 3 wherein the opening is fully enclosed.

5. The conduit clip claim of claim 1 wherein the first partially enclosed ring and the second partially enclosed ring extend in a parallel direction.

6. The conduit clip claim of claim 1 wherein the first partially enclosed ring and the second partially enclosed ring extend in a non-parallel direction.

7. The conduit clip of claim 1 wherein at least one of the first slot and the second slot are rectangular.

8. The conduit clip of claim 1 wherein the first partially enclosed ring is about 60% to about 80% enclosed.

9. The conduit clip of claim 1 wherein the first partially enclosed ring is about 65% to about 70% enclosed.

10. The conduit clip claim of claim 1 wherein the bottom surface comprises a plurality of gripping projections.

11. A conduit clip comprising:
a top surface defining a pair of partially enclosed rings extending from a front face to a rear face;
a bottom surface defining a lower partially enclosed ring extending from the front face to the rear face of the body,
a first side face defining a first slot configured to receive a first flexible fastener, the first slot extending from the bottom surface to the top surface; and
a second side face defining a second slot configured to receive the first flexible fastener, the second slot extending from the bottom surface to the top surface.

12. The conduit clip of claim 11 wherein the first side face defines an opening extending to the second side face.

13. The conduit clip of claim 12 wherein the opening is positioned within the first slot and the second slot.

14. The conduit clip of claim 13 wherein the opening is fully enclosed.

15. The conduit clip of claim 1 wherein a radius of one of the pair of partially enclosed rings is the same as a radius of the other partially enclosed ring.

16. The conduit clip of claim 11 wherein the pair of partially enclosed rings are each about 60% to about 80% enclosed.

17. The conduit clip of claim 11 wherein the pair of partially enclosed rings are each about 65% to about 70% enclosed.

18-20. (canceled)
